(19) United States
(12) Patent Application Publication
(10) Pub. No.: US 2025/0166420 A1
(43) Pub. Date: May 22, 2025

(54) UPDATE NOTIFICATION APPARATUS, AUTHENTICATION APPARATUS, UPDATE NOTIFICATION METHOD, AND COMPUTER-READABLE MEDIUM

(71) Applicant: NEC Corporation, Minato-ku, Tokyo (JP)

(72) Inventors: Yuta SHIMIZU, Tokyo (JP); Kazuki INAGAKI, Tokyo (JP); Koyo SHIBATA, Tokyo (JP); Kohei HIJIKATA, Tokyo (JP)

(73) Assignee: NEC Corporation, Minato-ku, Tokyo (JP)

(21) Appl. No.: 18/841,432

(22) PCT Filed: Mar. 1, 2022
(86) PCT No.: PCT/JP2022/008586

§ 371 Date: Aug. 26, 2024

(51) Int. Cl. G06V 40/50; G06V 10/75; G06V 10/764; G06V 40/16

(52) U.S. Cl. CPC G06V 40/50; G06V 10/751; G06V 10/764; G06V 40/171; G06V 40/172

(57) ABSTRACT

Face image acquiring means acquires a face image of an authentication target person from a captured image of an imaging device. Authentication means verifies the acquired face image of the authentication target person with the registered image, and performs authentication with respect to the authentication target person. When the authentication succeeds, calculation means verifies the face image of the authentication target person with a face image obtained when the authentication target person has succeeded in the authentication in the past, and calculates a score. Determination means determines whether to prompt the authentication target person to update the registered image based on the calculated score. Notification means transmits a notification prompting the authentication target person to update the registered image.

### TECHNICAL FIELD

The present disclosure relates to an update notification apparatus, an authentication apparatus, an update notification method, and a computer-readable medium.

### BACKGROUND ART

As a related technique, Patent Literature 1 discloses a face authentication system. In the face authentication system described in Patent Literature 1, a face authentication machine transmits a face image of a person to be authenticated to an authentication server. The authentication server verifies the face image of the person to be authenticated with a registered face image registered in a registrant database. When a verification score is equal to or more than a predetermined threshold, the authentication server specifies that a person of the registered face image is the person to be authenticated.

The authentication server aggregates verification scores for each registrant and calculates an average score. The authentication server extracts an authenticator having a low score as a user who is a target person of face image update based on the average score. The authentication server extracts, for example, a user whose average score is decreased than a value (for example, 0.8) slightly larger than a threshold (for example, 0.75) for success of the face authentication as the target person of the face image update. The authentication server extracts, as candidate images, some images of the person to be authenticated obtained when the target person of the face image update has succeeded in the face authentication in the past. An administrator selects an optimal candidate image from among the candidate images. The authentication server updates the registered image in the registrant database with the candidate image selected by the administrator.

### CITATION LIST

### Patent Literature

Patent Literature 1: Japanese Unexamined Patent Application Publication No. 2021-157649

### SUMMARY OF INVENTION

### Technical Problem

In Patent Literature 1, the registered image is updated based on the verification score between the registered image and the face image of the person to be authenticated. In Patent Literature 1, by specifying a user whose face changes due to aging or the like and tends to have a low score, it is possible to perform update processing for a user who needs to be updated. However, in Patent Literature 1, a face image captured at the time of authentication is used as a registered image. For this reason, when the related technique described in Patent Literature 1 is applied in a case where the registered image is captured in an environment different from the image of the person to be authenticated, the verification score between the registered image and the image of the person to be authenticated may decrease depending on the environment or the like, and it may be unnecessarily determined that update is required.

In view of the above circumstances, an object of the present disclosure is to provide an update notification apparatus, an authentication apparatus, an update notification method, and a computer-readable medium that can prompt a user to update a registered image at an appropriate timing.

### Solution to Problem

In order to achieve the above object, the present disclosure provides, as a first aspect, an update notification apparatus. An update notification apparatus includes: calculation means for, when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification; determination means for determining whether to prompt the authentication target person to update a registered image used for the authentication based on the score: and notification means for transmitting a notification prompting the authentication target person to update the registered image when it is determined to prompt the authentication target person to update the registered image.

The present disclosure provides, as a second aspect, an authentication apparatus. An authentication apparatus includes: face image acquiring means for acquiring a face image of an authentication target person from a captured image acquired from an imaging device that captures an image of the authentication target person: authentication means for verifying the acquired face image of the authentication target person or a feature amount extracted from the face image with a registered image of a registrant or a feature amount extracted from the registered image to perform authentication with respect to the authentication target person: calculation means for, when the authentication succeeds, verifying the acquired face image of the authentication target person or the feature amount with a face image or the feature amount obtained when the authentication target person has succeeded in the authentication in the past, and calculating a score indicating a matching degree of the verification: determination means for determining whether to prompt the authentication target person to update the registered image based on the score: and notification means for transmitting a notification prompting the authentication target person to update the registered image when it is determined to prompt the update of the registered image.

The present disclosure provides, as a third aspect, an update notification method. An update notification method includes: when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification: determining whether to prompt the authentication target person to update a registered image used for the authentication based on the score: and transmitting a notification prompting the authentication target person to update the registered image when it is determined to prompt the update of the registered image.

The present disclosure provides, as a fourth aspect, a computer-readable medium. A computer-readable medium stores a program for causing a computer to execute processing, the processing including: when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification: determining whether to prompt the authentication target person to update a registered image used for the authentication based on the score: and transmitting a notification prompting the authentication target person to update the registered image when it is determined to prompt the update of the registered image.

### Advantageous Effects of Invention

In view of the above circumstances, an object of the present disclosure is to provide an update notification apparatus, an authentication apparatus, an update notification method, and a computer-readable medium that can prompt a user to update a registered image at an appropriate timing.

### BRIEF DESCRIPTION OF DRAWINGS

FIG. 1 is a block diagram schematically illustrating an authentication system including an authentication apparatus according to the present disclosure.

FIG. 2 is a block diagram illustrating an authentication system including an authentication apparatus according to one example embodiment of the present disclosure.

FIG. 3 is a diagram illustrating an example of face information stored in a face information DB.

FIG. 4 is a flowchart illustrating an operation procedure in the authentication apparatus.

FIG. 5 is a schematic diagram schematically illustrating face authentication.

FIG. 6 is a schematic diagram schematically illustrating calculation of scores in a score calculation unit.

FIG. 7 is a block diagram illustrating an example of a hardware configuration of a computer device.

### EXAMPLE EMBODIMENT

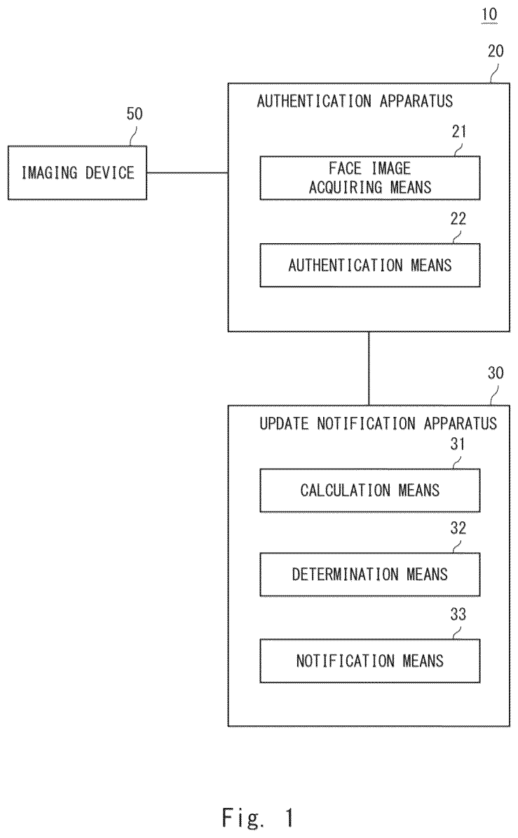

Prior to describing an example embodiment of the present disclosure, an outline of the present disclosure will be described. FIG. 1 schematically illustrates an authentication system including an authentication apparatus according to the present disclosure. An authentication system 10 includes an authentication apparatus 20, an update notification apparatus 30, and an imaging device 50. The imaging device 50 captures an image of an authentication target person. The authentication apparatus 20 acquires a captured image from the imaging device 50 and authenticates the authentication target person. The update notification apparatus 30 determines whether to prompt a user to update a registered image used for authentication in the authentication apparatus 20. Note that the authentication apparatus 20 and the update notification apparatus 30 are not necessarily configured as independent apparatuses. For example, the update notification apparatus 30 may be included in the authentication apparatus 20.

The authentication apparatus 20 has face image acquiring means 21 and authentication means 22. The face image acquiring means 21 acquires a face image of the authentication target person from the captured image of the imaging device 50. The authentication means 22 verifies the face image of the authentication target person with a registered image of a registrant, and performs authentication with respect to the authentication target person. In the authentication of the authentication target person, the authentication means 22 may verify a feature amount extracted from the face image of the authentication target person with a feature amount extracted from the registered image of the registrant.

The update notification apparatus 30 has calculation means 31, determination means 32, and notification means 33. When the authentication of the authentication target person succeeds in the authentication apparatus 20, the calculation means 31 verifies the face image of the authentication target person acquired by the face image acquiring means 21 with a face image obtained when the authentication target person has succeeded in the authentication in the past, and calculates a score indicating a matching degree of the verification. The calculation means 31 may verify a feature amount extracted from the face image with a feature amount extracted from the face image for which the authentication has succeeded in the past.

The determination means 32 determines whether to prompt the authentication target person to update the registered image based on the score calculated by the calculation means 31. In a case where the determination means 32 determines to prompt the update of the registered image, the notification means 33 transmits a notification prompting the update of the registered image to the authentication target person.

Here, in the face authentication, the face of the user may change with the elapse of the time, and an authentication accuracy may decrease due to the change. In order to suppress the decrease in the authentication accuracy, the user may periodically update the registered image. However, the user may forget to update the registered image, and in that case, an old registered image continues to be used. In addition, the user may feel troublesome to update the registered image, and it is required to present the update of the registered image to the user at an appropriate timing.

In the present disclosure, the calculation means 31 verifies the face image acquired by the face image acquiring means 21 with the face image for which the authentication has succeeded in the past, and calculates a score. The determination means 32 determines whether to prompt the authentication target person to update the registered image based on the calculated score, and the notification means 33 transmits a notification prompting the authentication target person to update the registered image. In the present disclosure, in a case where the verification score becomes low with respect to the face image for which the authentication has succeeded in the past, a notification prompting the update of the registered image is transmitted to the user.

In the related technique including Patent Literature 1, the registered image is updated based on the verification score between the image of the person to be authenticated and the registered image. However, in that case, when an image capturing environment, an image capturing condition, and the like are different between the registered image and the face image actually used for authentication, there is a case where a change in the face cannot be appropriately detected. In the present disclosure, the face images captured by using the imaging device 50 are verified with each other, and whether to prompt update of the registered image is determined based on the verification score. Therefore, even when the registered image used for authentication is different from the image captured using the imaging device 50, the update notification apparatus 30 can prompt the user to update the registered image at an appropriate timing. The user can receive the notification prompting update of the registered image at an appropriate timing, and can update the registered image without feeling annoyance. The user can continuously enjoy the security and convenience of the face authentication by updating the registered image at an appropriate timing.

Hereinafter, the example embodiment of the present disclosure will be described in detail with reference to the drawings. Note that in the description and drawings to be described below, omission and simplification are made as appropriate, for clarity of description. In addition, in each of the drawings described below, the same elements and similar elements are denoted by the same reference signs, and a duplicate description is omitted as necessary.

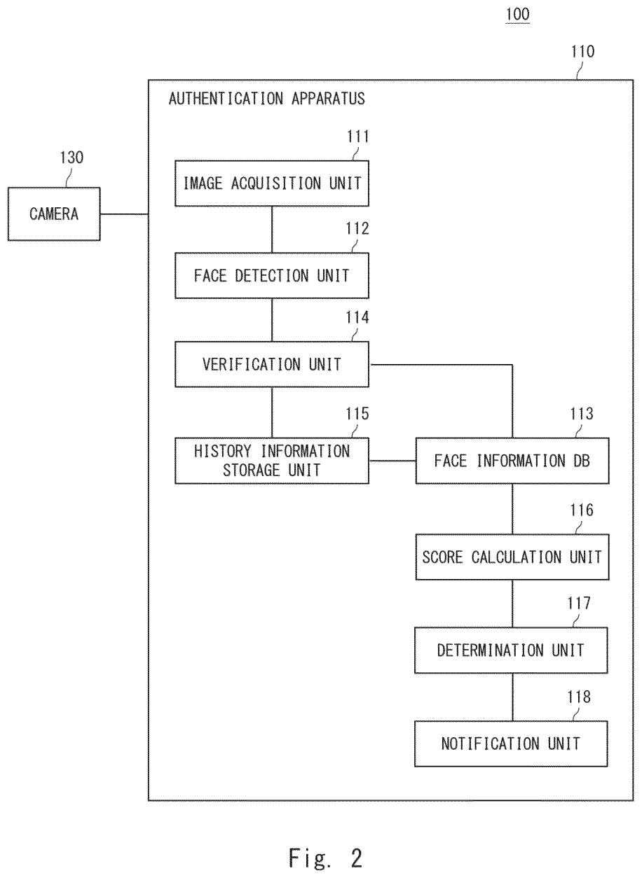

FIG. 2 illustrates an authentication system including an authentication apparatus according to one example embodiment of the present disclosure. An authentication system 100 has an authentication apparatus 110 and a camera 130. Hereinafter, an example in which the authentication system 100 is used for a vehicle interior entry in a vehicle such as an automobile will be described. The authentication system 100 is not limited to the vehicle interior entry, and can be applied to authentication in various systems. The authentication system 100 corresponds to the authentication system 10 illustrated in FIG. 1.

The camera 130 captures an image of an authentication target person (subject). In the present example embodiment, it is assumed that the camera 130 captures an image of a subject who is outdoors. The camera 130 captures, for example, an image of a person who is about to get on a vehicle. The vehicle is a moving object such as a passenger car, a taxi, or a van. The camera 130 is mounted on the vehicle, for example, and captures an image of the subject outside the vehicle from an inside of the vehicle. The camera 130 may be installed outside the vehicle and capture the image of the subject approaching the vehicle. In the authentication system 100, the number of cameras 130 is not limited to one. The authentication system 100 may have a plurality of cameras 130. The camera 130 corresponds to the imaging device 50 illustrated in FIG. 1.

The authentication apparatus 110 acquires the image of the subject from the camera 130, and performs authentication with respect to the subject using the acquired image. The authentication apparatus 110 is mounted on the vehicle, for example. The authentication apparatus 110 has an image acquisition unit 111, a face detection unit 112, a face information database (DB) 113, a verification unit 114, a history information storage unit 115, a score calculation unit 116, a determination unit 117, and a notification unit 118. The authentication apparatus 110 is configured as an apparatus including, for example, one or more processors and one or more memories. At least a part of the function of each unit in the authentication apparatus 110 can be realized by the processor performing processing according to a program read from the memory. The authentication apparatus 110 corresponds to the authentication apparatus 20 and the update notification apparatus 30 illustrated in FIG. 1.

The image acquisition unit 111 acquires a video (image) captured by the camera 130. The image acquisition unit 111 sequentially acquires latest image data captured by the camera 130. The face detection unit 112 detects a face area (face image) from the image data acquired by the image acquisition unit 111. The face detection unit 112 corresponds to the face image acquiring means 21 illustrated in FIG. 1.

The face information DB 113 stores face information of each of one or more authentication target users (registrants). Each user registers his/her face image in the authentication apparatus 110. Each user registers, for example, a camera image captured by his/her smartphone or digital camera in the authentication apparatus 110. The face information DB 113 stores the registered face image as a master. The face image registered by the user is also referred to as a registered image. In addition to or instead of the registered image, the face information DB 113 may store a feature amount extracted from the registered image as a master.

Note that the face information DB 113 is not necessarily included in the authentication apparatus 20. The face information DB 113 may be configured using, for example, a storage device connected to the authentication apparatus 20 via a network.

The verification unit 114 verifies the face image detected by the face detection unit 112 with the registered image registered in the face information DB 113. More specifically, the verification unit 114 acquires a registered image of each user from the face information DB 113. The verification unit 114 verifies the face image detected by the face detection unit 112 with the acquired registered image of each user. For example, the verification unit 114 extracts a feature amount of a face from the face image detected by the face detection unit 112, and compares the extracted feature amount with a feature amount extracted from the registered image.

The verification unit 114 calculates a verification score indicating a matching degree or a similarity degree between the face image of the subject and the registered image. In the following description, it is assumed that the higher the matching degree or the similarity degree, the higher the verification score. The verification unit 114 calculates the verification score for each of one or more users. The verification unit 114 determines whether the face authentication is successful based on the verification score. For example, the verification unit 114 compares the verification score calculated for each user with a threshold, and determines whether the face authentication is successful based on the result of the comparison.

For example, in a case where a verification score between a face image of a subject and a registered image of a certain user is a threshold or more, the verification unit 114 determines that face authentication is successful. When the face authentication succeeds, the verification unit 114 identifies that the subject is a registrant having a highest verification score. The verification unit 114 corresponds to the authentication means 22 illustrated in FIG. 1.

The authentication apparatus 110 outputs the authentication result to a device (not illustrated) such as an electronic control unit (ECU) that controls the vehicle. When the subject is authenticated as a user registered in advance, the

ECU unlocks doors of the vehicle and permits the user to get on the vehicle. The ECU does not unlock the doors of the vehicle when the subject is not authenticated as the user registered in advance.

The face information DB 113 stores, for each user, the face image of the subject for which the face authentication has succeeded or a feature amount thereof as history information in addition to the registered image. When the face authentication succeeds in the verification unit 114, the history information storage unit (history information storage means) 115 stores the face image detected by the face detection unit 112 or the feature amount thereof in the face information DB 113 as the face image for which the face authentication has succeeded in the past. For example, for each user, when the user first succeeds in authentication for the first time after the registered image is registered, the history information storage unit 115 may store the face image in the face information DB 113 as the face image for which the face authentication has succeeded in the past. For example, for each user, the history information storage unit 115 may store, in the face information DB 113, the face image for which the face authentication has succeeded in the face authentication performed a plurality of times in the past.

When the subject succeeds in the face authentication, the score calculation unit 116 verifies the face image detected by the face detection unit 112 with the face image obtained when the subject has succeeded in face authentication in the authentication in the past, and calculates a score indicating a matching degree of the verification. The score calculation unit 116 acquires, from the face information DB 113, a face image obtained when the subject has succeeded in face authentication in the authentication in the past. For example, the score calculation unit 116 may acquire an oldest face image among a plurality of face images stored in the face information DB 113 as a face image for which authentication has succeeded in the past. The score calculation unit 116 verifies the acquired past face image with the current face image detected by the face detection unit 112. The score calculation unit 116 may verify the feature amounts extracted from the face images. The score calculation unit 116 may store the calculated score in the face information DB 113. The score calculation unit 116 corresponds to the calculation means 31 illustrated in FIG. 1.

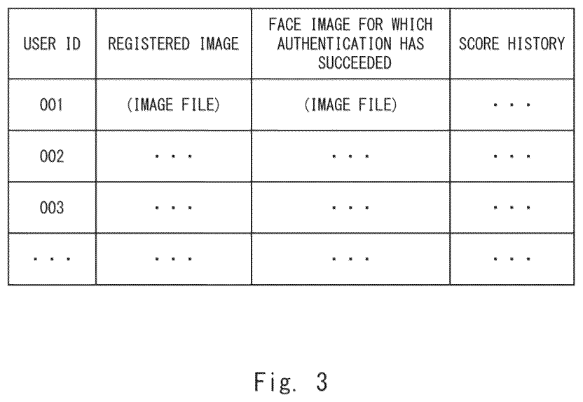

FIG. 3 illustrates an example of face information stored in the face information DB 113. In FIG. 3, a user identifier (ID) indicates an ID for identifying each user. The ghost information DB 113 stores a registered image and a face image for which face authentication has succeeded in the past for each user. The registered image may be an image captured using the camera 130 or an image captured using an imaging device different from the camera 130. On the other hand, the face image for which the face authentication has succeeded in the past is an image captured by the camera 130 when the verification unit 114 determines that the face authentication is successful. Score history indicates a history of scores of the face image for which face authentication has succeeded in the past and the face image of the subject, calculated by the score calculation unit 116.

The history information storage unit 115 may further store at least one of a face state in the face image and an image capturing condition when the face image is captured in the face information DB 113 as the history information for the face image for which the face authentication has succeeded. The face state includes, for example, at least one of a face orientation and a presence or absence of wearing a mask. The image capturing condition includes at least one of weather, date and time, and an image capturing place. The score calculation unit 116 may classify the face image into one of a plurality of groups based on at least one of the face state in the face image and the image capturing condition. In that case, the score calculation unit 116 may acquire a face image belonging to the same group as a group to which the current face image belongs among the past face images stored in the face information DB 113 as a face image obtained when the authentication target person has succeeded in face authentication in the past. In that case, it is possible to verify face images of which face states and image capturing states are close to each other.

The determination unit 117 determines whether to prompt the subject to update the registered image based on the score calculated by the score calculation unit 116. In other words, the determination unit 117 determines whether it is desirable to update the registered image based on the calculated score. For example, the determination unit 117 determines whether the score calculated by the score calculation unit 116 is equal to or less than a threshold. The reason why the score is low is considered to be that the time has elapsed from the registration of the registered image and the face has changed. In a case where the determination unit 117 determines that the calculated score is equal to or less than a threshold, the determination unit 117 determines that it is desirable to update the registered image.

For example, the determination unit 117 may determine whether the score has decreased based on a past score (history thereof) stored in the ghost information DB 113 and a current score calculated by the score calculation unit 116. For example, the determination unit 117 determines that it is desirable to update the registered image in a case where the score shows a decreasing tendency and the current score is less than a predetermined value in the face authentication performed a plurality of times in the past. The determination unit 117 corresponds to the determination means 32 illustrated in FIG. 1.

When the determination unit 117 determines that it is desirable to update the registered image, the notification unit 118 transmits a notification prompting the subject to update the registered image. The notification unit 118 transmits a message prompting the subject to update the registered image by using, for example, an e-mail. For example, after receiving the notification, the subject captures his/her face image using a smartphone or the like. The subject can register the registered image in the face information DB 113 through registration means (not illustrated). The notification unit 118 corresponds to the notification means 33 illustrated in FIG. 1.

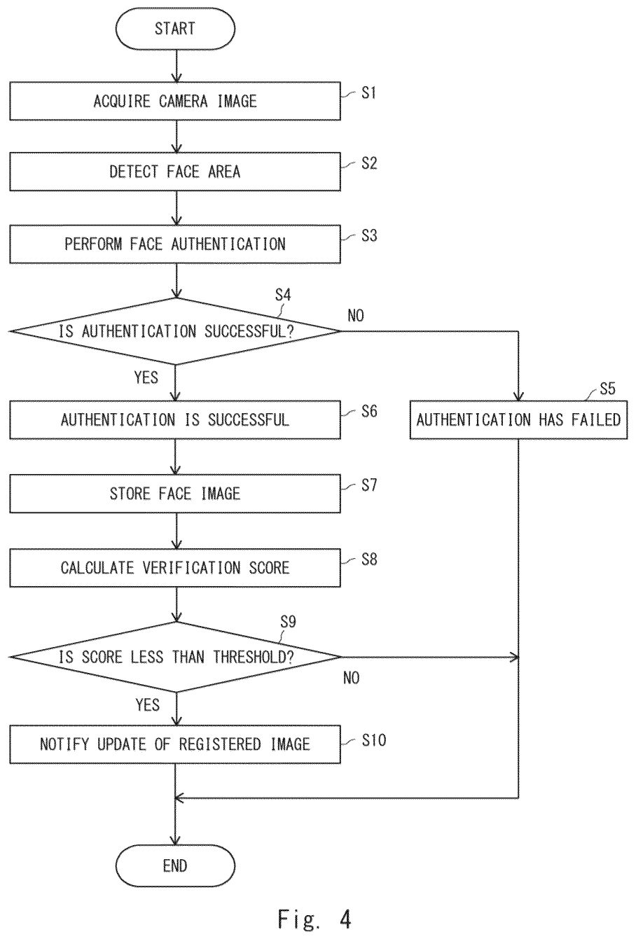

Next, an operation procedure will be described. FIG. 4 illustrates an operation procedure in the authentication apparatus 110. The image acquisition unit 111 acquires a camera image from the camera 130 (step S1). The image acquisition unit 111 periodically performs step S1, and acquires camera images in time series from the camera 130 that captures a moving image. The face detection unit 112 detects a face area from the camera image acquired by the image acquisition unit 111 (step S2). The face detection unit 112 outputs the image (face image) of the face area detected in step S2 to the verification unit 114.

The verification unit 114 performs face authentication on the face image input from the face detection unit 112 (step S3). In the face authentication, the verification unit 114 verifies the face image input from the face detection unit 112 with each of the registered images registered in the face information DB 113. The verification unit 114 calculates a verification score of each registered image with the face image input from the face detection unit 112. The verification unit 114 determines whether the face authentication is successful based on the calculated verification score (step S4). In step S4, the verification unit 114 compares the verification score calculated for each registered image with a threshold, and determines whether the verification score is equal to or more than the threshold.

When the verification score is smaller than the threshold, the verification unit 114 determines that the face authentication has failed in step S4. In that case, the verification unit 114 outputs a message indicating that the face authentication has failed (step S5). When the face authentication has failed, the authentication apparatus 110 may return to step S1 and restart the face authentication from the beginning. In a case where the verification score is equal to or more than the threshold, the verification unit 114 determines that the face authentication is successful in step S4. In that case, the verification unit 114 outputs a message indicating that the face authentication is successful (step S6). In step S6, the verification unit 114 also outputs a user ID corresponding to the registered image having a highest verification score with the face image input from the face detection unit 112.

When the face authentication succeeds, the history information storage unit 115 stores the face image verified with the registered image in the face information DB 113 as the face image for which face authentication has succeeded in the past (step S7). The score calculation unit 116 acquires, from the face information DB 113, the face image for which the face authentication has succeeded in the past. The score calculation unit 116 acquires, from the face information DB 113, a face image for which the face authentication has succeeded in the past, corresponding to a user ID identified in the face authentication. In the score calculation unit 116, the score calculation unit 116 calculates a score by verifying the face image detected in step S2 with the face image for which the face authentication has succeeded in the past acquired from the face information DB 113 (step S8).

The determination unit 117 compares the score calculated in step S8 with a predetermined threshold (step S9). The threshold compared in step S9 may be the same as or different from the threshold used for determining whether the face authentication is successful in step S4. In step S9, the determination unit 117 determines whether the calculated score is less than a threshold. In a case where the calculated threshold is less than the threshold, the determination unit 117 determines that it is desirable to update the registered image. In a case where the calculated threshold is equal to or more than the threshold, the determination unit 117 determines that the update of the registered image is not necessary.

In a case where it is determined that the score calculated in step S9 is less than the threshold, the notification unit 118 transmits a notification prompting update of the registered image to the subject (step S10). In a case where it is determined that the score calculated in step S9 is equal to or more than the threshold, the notification prompting the update of the registered image is not transmitted. The operations of steps S7 to S10 correspond to the operation of the update notification method of the registered image.

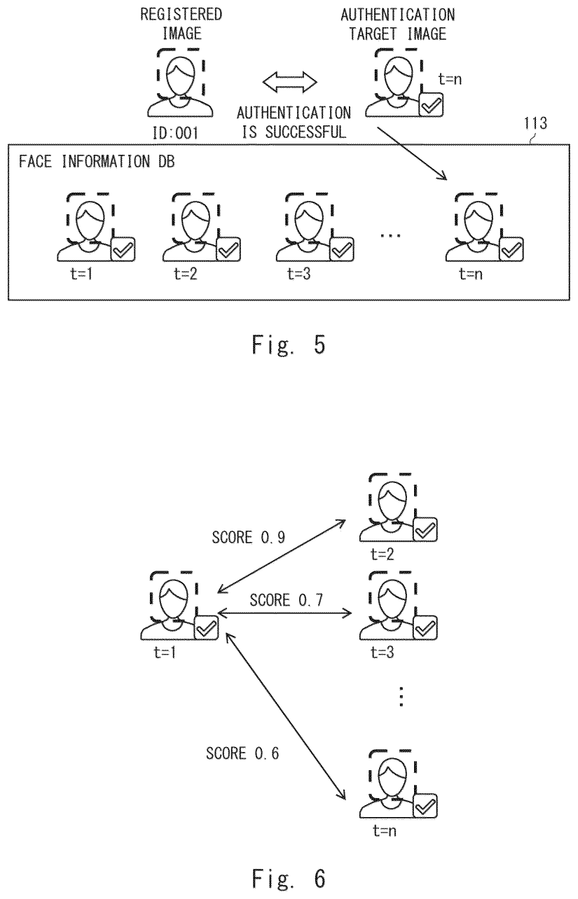

Hereinafter, a flow of processing will be described using a specific example. FIG. 5 schematically illustrates face authentication. In FIG. 5, an authentication target image indicates a face image of a subject detected by the face detection unit 112. The verification unit 114 verifies the authentication target image with the registered image to identify the subject. Here, it is assumed that the verification unit 114 identifies that the subject is a user having a user ID: 001. The history information storage unit 115 stores a current authentication target image for which face authentication has succeeded in the face information DB 113 as history information of the user having the user ID: 001. The face information DB 113 stores the authentication target image at each time from time t=1 to time t=n for the user having the user ID: 001. It is assumed that time t=1 is an oldest time and t=n is a latest time. The time t=1 may be a time when the face authentication is first performed after the registration of the registered image.

FIG. 6 schematically illustrates an example of score calculation in the score calculation unit 116. The score calculation unit 116 selects an authentication target image of t=1 with the oldest time among a plurality of past authentication target images stored in the face information DB 113 as a reference image. The score calculation unit 116 calculates a score (verification score) between the authentication target image of t=1 selected as the reference and the authentication target image at each time. A method of calculating the score in the score calculation unit 116 may be the same as the method of calculating the verification score in the verification unit 114. In a case where the history of scores of previous times is stored in the face information DB 113, the score calculation unit 116 only needs to calculate scores only between the authentication target image of t=1 and the authentication target image of t=n.

Referring to the example of FIG. 6, a score is 0.9 at time t=2, and a score is 0.7 at time t=3. When t=n, the score is 0.6. In this case, at t=n, although the face authentication is successful as a result of the verification with the registered image, the score decreases in the verification with the authentication target image at the oldest time. For example, in a case where a threshold is 0.65, the determination unit 117 determines that it is desirable to update the registered image at t=n. In that case, the notification unit 118 transmits a message prompting the user having the user ID: 001 to update the registered image. The user who has received the message updates the registered image as necessary.

In the present example embodiment, the score calculation unit 116 verifies the face image detected by the face detection unit 112 with the face image for which the face authentication has succeeded in the past, and calculates a score. The determination unit 117 determines whether it is desirable to update the registered image according to the calculated score. In a case where it is determined that it is desirable to update the registered image, the notification unit 118 transmits a notification prompting the user to update the registered image. In the present example embodiment, it is considered that the image captured by the camera 130 used for face authentication and the image captured as the registered image have different image capturing environments. In the present example embodiment, a notification prompting update of the registered image is transmitted according to the score with the past authentication target image. Therefore, it is possible to eliminate the score decrease due to the difference in the image capturing environment and prompt the user to update the registered image at an appropriate timing.

In the above example embodiment, the score calculation unit 116 may further verify each of the registered images with each of the authentication target images (see FIG. 5) at each time stored in the face information DB 113, and may further calculate a verification score with the registered image. For example, the determination unit 117 calculates a decrease amount of a highest verification score at each time, which is expected to be a personal score. The decrease in the personal score may indicate that the face of the subject has changed from the face of the subject's registered image. The determination unit 117 may determine that the update of the registered image is desirable in a case where the decrease amount of the personal score from the time t=1 to the time t=n is equal to or more than a predetermined threshold. As another example, the determination unit 117 may determine that the update of the registered image is desirable when a difference between an average of the personal scores and the threshold of the verification score for determining that the authentication is successful is smaller than a predetermined reference value.

Alternatively, the determination unit 117 may calculate, as an another-person score (an average value thereof), an average value of other verification scores except for the highest verification score at each time. In that case, the determination unit 117 calculates an increase amount of the another-person score. The increase in the another-person score may indicate that the face of the subject is becoming similar to the face of another person's registered image. The determination unit 117 may determine that the update of the registered image is desirable in a case where the increase amount of the another-person score from the time t=1 to the time t=n is equal to or more than a predetermined threshold. As another example, the determination unit 117 may determine that the update of the registered image is desirable in a case where a difference between the another-person score (the average thereof) and the threshold of the verification score for determining that the authentication is successful is smaller than a predetermined reference value.

In the above example embodiment, the history information storage unit 115 may determine whether to store the face image in the face information DB 113 based on a face state in the face image detected by the face detection unit 112. The history information storage unit 115 may not store the face image in the face information DB 113 even when the face authentication succeeds, for example, in a case where the subject's face is sideways. The history information storage unit 115 may not store the face image in the face information DB 113 even when the face authentication succeeds in a case where a brightness of the face image does not reach a predetermined reference, that is, in a case where the image is dark. In such a case, it is possible to suppress a decrease in the score calculated by the score calculation unit 116 due to an element other than a secular change of the face, and transmission of a notification prompting the user to update the registered image.

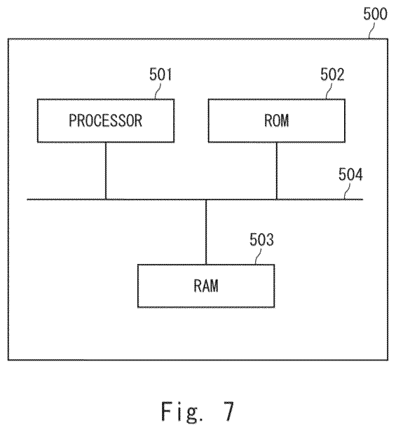

Next, a hardware configuration of the authentication apparatus 110 will be described. FIG. 7 illustrates an example of a hardware configuration of a computer device that can be used for the authentication apparatus 110. The computer device 500 has a processor (central processing unit (CPU)) 501, a read only memory (ROM) 502, and a random access memory (RAM) 503. In the computer device 500, the processor 501, the ROM 502, and the RAM 503 are connected to one another via a bus 504. Although not illustrated, the authentication apparatus 110 may include other circuits such as a peripheral circuit, a communication circuit, and an interface circuit.

The ROM 502 is a non-volatile storage device. For example, a semiconductor storage device such as a flash memory having a relatively small capacity is used for the ROM 502. The ROM 502 stores a program executed by the processor 501.

The program described above includes a group of commands (or software codes) for causing a computer to perform one or more functions described in the example embodiment when being read by the computer. The program may be stored in a non-transitory computer-readable medium or a tangible storage medium. As an example and not by way of limitation, a computer-readable medium or tangible storage medium includes a RAM, a ROM, a flash memory, a solid-state drive (SSD) or other memory technique, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. By way of example, and not limitation, transitory computer-readable or communication media include electrical, optical, acoustic, or other forms of propagated signals.

The RAM 503 is a volatile storage device. As the RAM 503, various types of semiconductor memory devices such as a dynamic random access memory (DRAM) or a static random access memory (SRAM) can be used. The RAM 503 can be used as an internal buffer for transitory storing data and the like.

The processor 501 loads the program stored in the ROM 502 in the RAM 503, and executes the program. Functions of the respective units in the authentication apparatus 110 can be realized by the CPU 501 executing the program.

In the above example embodiment, the authentication apparatus 110 is not necessarily a single apparatus. The authentication apparatus 110 may be configured using a plurality of physically separated apparatuses. In addition, in a case where the authentication apparatus 110 is used for the vehicle interior entry, the authentication apparatus 110 does not necessarily have all the functions mounted on the vehicle. For example, each unit of the authentication apparatus 110 may be disposed outside the vehicle. In that case, the authentication apparatus 110 may acquire a camera image of the camera 130 via a wireless communication network. The authentication apparatus 110 may transmit an authentication result to the vehicle via a wireless communication network.

Although the example embodiment according to the present disclosure has been described above in detail, the present disclosure is not limited to the above-described example embodiment, and the present disclosure also includes those that are obtained by making changes or modifications to the above-described example embodiment without departing from the spirit of the present disclosure.

For example, some or all of the above-described example embodiment may be described as the following supplementary notes, but the present disclosure is not limited to the following supplementary notes.

### Supplementary Note 1

An update notification apparatus including:
calculation means for, when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification:
determination means for determining whether to prompt the authentication target person to update a registered image used for the authentication based on the score; and
notification means for transmitting a notification prompting the authentication target person to update the registered image when it is determined to prompt the update of the registered image.

### Supplementary Note 2

The update notification apparatus described in Supplementary Note 1, in which the determination means determines whether the score is equal to or less than a threshold, and when it is determined that the score is equal to or less than the threshold, determines to prompt the authentication target person to update the registered image.

### Supplementary Note 3

The update notification apparatus described in Supplementary Note 1 or 2, further including: history information storage means for storing at least one of the face image and the feature amount and the score as history information when the authentication target person succeeds in authentication,
in which the calculation means acquires a face image or the feature amount obtained when the authentication target person has authenticated in the past from the history information.

### Supplementary Note 4

The update notification apparatus described in Supplementary Note 3, in which
the history information includes a plurality of face images or the feature amounts, and
the calculation means acquires, from the history information, an oldest face image or the feature amount among the plurality of face images or the feature amounts included in the history information as the face image or the feature amount obtained when the authentication target person has succeeded in the authentication in the past.

### Supplementary Note 5

The update notification apparatus described in Supplementary Note 3 or 4, in which the calculation means classifies the face image into one of a plurality of groups based on at least one of a face state in the face image and an image capturing condition when the face image is captured, and acquires the face image or the feature amount belonging to the same group as a group to which the face image belongs among at least one of the face images and the feature amounts included in the history information as the face image or the feature amount obtained when the authentication target person has succeeded in the authentication in the past.

### Supplementary Note 6

The update notification apparatus described in Supplementary Note 5, in which the history information storage means further stores, as the history information, at least one of the face state in the face image and the image capturing condition when the face image is captured.

### Supplementary Note 7

The update notification apparatus described in Supplementary Note 5 or 6, in which the face state includes at least one of a face orientation and a presence or absence of wearing a mask.

### Supplementary Note 8

The update notification apparatus described in any one of Supplementary Notes 5 to 7, in which the image capturing condition includes at least one of weather, date and time, and an image capturing place.

### Supplementary Note 9

The update notification apparatus described in any one of Supplementary Notes 3 to 8, in which
the history information storage means further stores the score as the history information, and
the determination means determines whether the score is decreased based on the score included in the history information and the score calculated by the calculation means, and when it is determined that the score is decreased, determines to prompt the authentication target person to register the registered image.

### Supplementary Note 10

The update notification apparatus described in any one of Supplementary Notes 3 to 9, in which the history information storage means determines whether to store at least one of the face image and the feature amount as the history information based on the face state in the face image.

### Supplementary Note 11

An authentication apparatus including:
face image acquiring means for acquiring a face image of an authentication target person from a captured image acquired from an imaging device that captures an image of the authentication target person;
authentication means for verifying the acquired face image of the authentication target person or a feature amount extracted from the face image with a registered image of a registrant or a feature amount extracted from the registered image to perform authentication with respect to the authentication target person;
calculation means for, when the authentication succeeds, verifying the acquired face image of the authentication target person or the feature amount with a face image or the feature amount obtained when the authentication target person has succeeded in the authentication in the past, and calculating a score indicating a matching degree of the verification;
determination means for determining whether to prompt the authentication target person to update the registered image based on the score; and
notification means for transmitting a notification prompting the authentication target person to update the registered image when it is determined to prompt the update of the registered image.

### Supplementary Note 12

The authentication apparatus described in Supplementary Note 11, in which the determination means determines whether the score is equal to or less than a threshold, and when it is determined that the score is equal to or less than the threshold, determines to prompt the authentication target person to update the registered image.

### Supplementary Note 13

The authentication apparatus described in Supplementary Note 11 or 12, further including: history information storage means for storing at least one of the face image and the feature amount and the score as history information when the authentication target person succeeds in authentication,
in which the calculation means acquires a face image or the feature amount obtained when the authentication target person has authenticated in the past from the history information.

### Supplementary Note 14

An update notification method including:
when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification:
determining whether to prompt the authentication target person to update a registered image used for the authentication based on the score: and
transmitting a notification prompting the authentication target person to update the registered image when it is determined to prompt the update of the registered image.

### Supplementary Note 15

A non-transitory computer-readable medium that stores a program for causing a computer to execute processing, the processing including:
when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification;
determining whether to prompt the authentication target person to update a registered image used for the authentication based on the score; and
transmitting a notification prompting the authentication target person to update the registered image when it is determined to prompt the update of the registered image.

### REFERENCE SIGNS LIST

10 AUTHENTICATION SYSTEM
20 AUTHENTICATION APPARATUS
21 FACE IMAGE ACQUIRING MEANS
22 AUTHENTICATION MEANS
30 UPDATE NOTIFICATION APPARATUS
31 CALCULATION MEANS
32 DETERMINATION MEANS
33 NOTIFICATION MEANS
50 IMAGING DEVICE
100 AUTHENTICATION SYSTEM
110 AUTHENTICATION APPARATUS
111 IMAGE ACQUISITION UNIT
112 FACE DETECTION UNIT
113 FACE INFORMATION DB
114 VERIFICATION UNIT
115 HISTORY INFORMATION STORAGE UNIT
116 SCORE CALCULATION UNIT
117 DETERMINATION UNIT
118 NOTIFICATION UNIT
130 CAMERA
501 PROCESSOR
502 ROM
503 RAM
504 BUS

What is claimed is:

1. An update notification apparatus comprising:
at least one memory storing instructions; and
at least one processor configured to execute the instructions to:
verify, when authentication with respect to a face image of an authentication target person included in an image captured using a camera succeeds, the face image of the authentication target person or a feature amount extracted from the face image with a face image or the feature amount obtained when the authentication target person has succeeded in the authentication in the past, and calculate a score indicating a matching degree of the verification;
determine whether to prompt the authentication target person to update a registered image used for the authentication based on the score; and
transmit a notification prompting the authentication target person to update the registered image when it is determined to prompt the update of the registered image.

2. The update notification apparatus according to claim 1, wherein the at least one processor is configured to execute the instructions to determine whether the score is equal to or less than a threshold, and when it is determined that the score is equal to or less than the threshold, the at least one processor is configured to execute the instructions to determine to prompt the authentication target person to update the registered image.

3. The update notification apparatus according to claim 1, further comprising: history information storage storing at least one of the face image and the feature amount and the score as history information when the authentication target person succeeds in authentication,
wherein the at least one processor is configured to execute the instructions to acquire a face image or the feature amount obtained when the authentication target person has authenticated in the past from the history information.

4. The update notification apparatus according to claim 3, wherein
the history information includes a plurality of face images or the feature amounts, and
the at least one processor is configured to execute the instructions to acquire, from the history information, an oldest face image or the feature amount among the plurality of face images or the feature amounts included in the history information as the face image or the feature amount obtained when the authentication target person has succeeded in the authentication in the past.

5. The update notification apparatus according to claim 3, wherein the at least one processor is configured to execute the instructions to classify the face image into one of a plurality of groups based on at least one of a face state in the face image and an image capturing condition when the face image is captured, and acquire the face image or the feature amount belonging to the same group as a group to which the face image belongs among at least one of the face images and the feature amounts included in the history information as the face image or the feature amount obtained when the authentication target person has succeeded in the authentication in the past.

6. The update notification apparatus according to claim 5, wherein the history information storage further stores, as the history information, at least one of the face state in the face image and the image capturing condition when the face image is captured.

7. The update notification apparatus according to claim 5, wherein the face state includes at least one of a face orientation and a presence or absence of wearing a mask.

8. The update notification apparatus according to claim 5, wherein the image capturing condition includes at least one of weather, date and time, and an image capturing place.

9. The update notification apparatus according to claim 3, wherein
the history information storage further stores the score as the history information, and
the at least one processor is configured to execute the instructions to determine whether the score is decreased based on the score included in the history information and the calculated score, and when it is determined that the score is decreased, the at least one processor is configured to execute the instructions to determine to prompt the authentication target person to register the registered image.

10. The update notification apparatus according to claim 3, wherein the history information storage determines whether to store at least one of the face image and the feature amount as the history information based on the face state in the face image.

11. An authentication apparatus comprising:
the update notification apparatus according to claim 1, wherein
the at least one processor is further configured to execute the instructions to:
acquire a face image of an authentication target person from a captured image acquired from a camera that captures an image of the authentication target person; and
verify the acquired face image of the authentication target person or a feature amount extracted from the face image with a registered image of a registrant or a feature amount extracted from the registered image to perform authentication with respect to the authentication target person.

12. The authentication apparatus according to claim 11, wherein the at least one processor is configured to execute the instructions to determine whether the score is equal to or less than a threshold, and when it is determined that the score is equal to or less than the threshold, determine to prompt the authentication target person to update the registered image.

13. The authentication apparatus according to claim 11, further comprising: history information storage storing at least one of the face image and the feature amount and the score as history information when the authentication target person succeeds in authentication,
wherein the at least one processor is configured to execute the instructions to acquire a face image or the feature amount obtained when the authentication target person has authenticated in the past from the history information.

14. An update notification method comprising:
when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification;
determining whether to prompt the authentication target person to update a registered image used for the authentication based on the score; and
transmitting a notification prompting the authentication target person to update the registered image when it is determined to prompt the update of the registered image.

15. A non-transitory computer-readable medium that stores a program for causing a computer to execute processing, the processing comprising:
when authentication with respect to a face image of an authentication target person included in an image captured using an imaging device succeeds, verifying the face image of the authentication target person or a feature amount extracted from the face image with a face image or the feature amount obtained when the authentication target person has succeeded in the authentication in the past, and calculating a score indicating a matching degree of the verification;
determining whether to prompt the authentication target person to update a registered image used for the authentication based on the score; and
transmitting a notification prompting the authentication target person to update the registered image when it is determined to prompt the update of the registered image.
